(19) United States
(12) Patent Application Publication
(10) Pub. No.: US 2022/0297897 A1
(43) Pub. Date: Sep. 22, 2022

(54) MAGNETICALLY RE-SEALABLE FOOD STORAGE CONTAINER

(71) Applicants: Patrick Kealy, Hermosa Beach, CA (US); Rodney Houriani, Beverly Hills, CA (US)

(72) Inventors: Patrick Kealy, Hermosa Beach, CA (US); Rodney Houriani, Beverly Hills, CA (US)

(21) Appl. No.: 17/205,622

(22) Filed: Mar. 18, 2021

(51) Int. Cl. B65D 43/02; B65D 51/24; A47J 47/02

(52) U.S. Cl. CPC B65D 43/0202; B65D 51/242; A47J 47/02; B65D 2543/00092; B65D 2543/00203; B65D 2543/00518; B65D 2543/00537; B65D 2543/00555; B65D 2543/00851

(57) ABSTRACT

Described may be a magnetically resealable food storage container having a container body and a lid portion. The container body may have a container upper portion, a container opening, a container ledge, a container closure magnet, and a bottom container surface. The lid portion may a lid external end and a lid internal end. The lid internal end may be configured for placement against the container body and may further have a magnetic closing assembly or a magnetic lid ring. And the magnetic closing assembly may further comprise a lid closure magnet, a lid magnet housing, and a lid hinge. The lid hinge may connect the lid magnet housing to the lid internal end and may be further configured for a reversibly rotational clasping action between the lid closure magnet or and the container closure magnet or a magnetic track located on the container body.

### TECHNICAL FIELD

The disclosure herein relates generally to devices and methods for storage of foodstuffs via magnetic closure. More particularly, the disclosure relates to devices and methods to facilitate a more complete removal of oxygen from a container in which food is stored through the use of magnetically closing assemblies.

### BACKGROUND

It is well understood that food stays fresher when oxygen levels are reduced respective to the environment around the food. It was for this purpose that people began seeking methods to remove as much air from food storage systems as possible. However, many methods commonly used suffer from being overly complex, fail too often, and generally lack intuitive design. What is needed is a system which is reliable, simple to use, and is designed to work with an end users' needs in mind.

### SUMMARY

Certain deficiencies of the prior art are overcome by the provision of embodiments of an apparatus, kit and system in accordance with the present disclosure. Herein may be described and summarized as a magnetically resealable food storage container having a container body and a lid portion. The container body may have a container upper portion, a container opening, a container ledge, a container closure magnet, and a bottom container surface. The lid portion may an lid external end and a lid internal end. The lid internal end may be configured for placement against the container body and may further have a magnetic closing assembly. And the magnetic closing assembly may further comprise a lid closure magnet, a lid magnet housing, and a lid hinge. The lid hinge may connect the lid magnet housing to the lid internal end and may be further configured for a reversibly rotational clasping action between the lid closure magnet and the container closure magnet.

Further embodiments may be summarized and described as a magnetically resealable food storage container, which may have a container body and a lid portion. The container body having a container upper portion, a container opening, a container ledge, a magnetic track, and a bottom container surface. The lid portion may have a lid external end and a lid internal end. The lid internal end may be configured for placement towards the bottom container surface and may further have a magnetic lid ring and a handle ring. And, the magnetic lid ring may be configured for reversible engagement with the internal end of the container body and the handle ring may be configured for reversible magnetic connection with magnetic lid ring.

Further embodiments may be summarized and described as a magnetically resealable food storage container that may have a container body and a lid portion. The container body may have a container upper portion, a container opening, a container ledge, a container closure magnet, and a bottom container surface. The container upper portion herein may be defining of a top and the bottom container surface herein may be defining of a bottom. The container closure magnet of the container body may be elongated along a vertical axis with respect to the container upper portion and the bottom container surface. The lid portion may have a lid external end and a lid internal end. The lid internal end may be configured for placement against the container body and may further have a magnetic closing assembly. And, the magnetic closing assembly may further have a lid closure magnet, a lid magnet housing, and a lid hinge. The lid hinge may be connecting the lid magnet housing to the lid internal end and may be configured for a reversibly rotational clasping action between the lid closure magnet and the container closure magnet.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are not to be considered limiting of its scope, the disclosure will be described with additional specificity and detail through the use of accompanying drawings. Accordingly, further advantages of the present disclosure may become apparent to those skilled in the art with the benefit of the following detailed description of the preferred embodiments and upon reference to the accompanying drawings in which:

FIG. 1 is a perspective view of one non-limiting embodiment of a magnetically resealable food storage container;

FIG. 2 is a perspective view of one non-limiting embodiment of a magnetically resealable food storage container wherein a lid is elevated to show further assembly;

FIG. 3 is a cross-sectional view of one non-limiting embodiment of a magnetically resealable food storage container wherein a lid is elevated;

FIG. 4A is a cross-sectional view of one non-limiting embodiment of a magnetically resealable food storage container wherein a lid closure mechanism is shown as un-engaged;

FIG. 4B is a cross-sectional view of one non-limiting embodiment of a magnetically resealable food storage container wherein a lid closure mechanism is shown as engaged;

FIG. 5 is a cross-sectional view of one non-limiting embodiment of a magnetically resealable food storage container wherein a lid is elevated;

FIG. 6A is a cross-sectional view of one non-limiting embodiment of a magnetically resealable food storage container wherein a lid closure mechanism is shown as un-engaged;

FIG. 6B is a cross-sectional view of one non-limiting embodiment of a magnetically resealable food storage container wherein a lid closure mechanism is shown as engaged;

FIG. 7 is a perspective view of one non-limiting embodiment of a magnetically resealable food storage container;

FIG. 8 is an exploded view of one non-limiting embodiment of a magnetically resealable food storage container;

FIG. 9 is a cross-sectional view of one non-limiting embodiment of a magnetically resealable food storage container wherein a lid closure mechanism is shown as engageable;

FIG. 10 is a cross-sectional view of one non-limiting embodiment of a magnetically resealable food storage container wherein a lid closure mechanism is shown as engageable;

FIG. 11 is a perspective view of one non-limiting embodiment of a magnetically resealable food storage container wherein a lid assembly is illustrated and shown;

FIG. 12 is a perspective view of one non-limiting embodiment of a magnetically resealable food storage container wherein a lid assembly is illustrated and shown;

FIG. 13 is a cross-sectional view of one non-limiting embodiment of a magnetically resealable food storage container wherein a lid assembly is illustrated and shown as elevated;

FIG. 14A is a cross-sectional view of one non-limiting embodiment of a magnetically resealable food storage container wherein a lid closure mechanism is shown as partially-engaging;

FIG. 14B is a cross-sectional view of one non-limiting embodiment of a magnetically resealable food storage container wherein a lid closure mechanism is shown as engageable;

FIG. 15 is a cross-sectional view of one non-limiting embodiment of a magnetically resealable food storage container wherein a lid closure mechanism is shown as engageable;

FIG. 16 is a cross-sectional view of one non-limiting embodiment of a magnetically resealable food storage container wherein a lid closure mechanism is shown as engageable;

FIG. 17 is a perspective view of one non-limiting embodiment of a magnetically resealable food storage container wherein a lid closure mechanism is shown as partially elevated;

FIG. 18 is a perspective view of one non-limiting embodiment of a magnetically resealable food storage container wherein a lid closure mechanism is shown as elevated;

FIG. 19 is a cross-sectional view of one non-limiting embodiment of a magnetically resealable food storage container wherein a lid closure mechanism is shown as partially elevated; and,

FIG. 20 is a cross-sectional view of one non-limiting embodiment of a magnetically resealable food storage container wherein a lid closure mechanism is shown as engageable.

### DESCRIPTION OF THE EMBODIMENTS

Embodiments of systems, components, and methods of assembly and manufacture will now be described with reference to the accompanying figures. Although several embodiments, examples, and illustrations are disclosed below, it will be understood by those of ordinary skill in the art that the embodiments described herein extend beyond the specifically disclosed configurations, examples, and illustrations, and can include other users of the disclosure and obvious modifications and equivalents thereof. The terminology used in the descriptions presented herein is not intended to be interpreted in any limited or restrictive manner simply because it is being used in conjunction with a detailed description of certain specific embodiments of the disclosure. In addition, embodiments of the disclosure can comprise several novel features and no single feature is solely responsible for its desirable attributes or is essential to practicing any one of the several embodiments herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” “top,” “bottom” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specially mentioned above, derivatives thereof, and words of similar import. Moreover, the terms magnet and/or magnetic refer to the natural properties of magnetism as understood by the discipline of physics. The magnetic components used here may be of any type, with all due design and engineering considerations given to the relative strengths of the magnets type and variety.

Referring to the drawings, like reference numerals designate identical or corresponding features throughout the several views. Described herein are certain non-limiting embodiments of a magnetically resealable food storage container 100 for use in the application and support of the storage and preservation of foodstuffs.

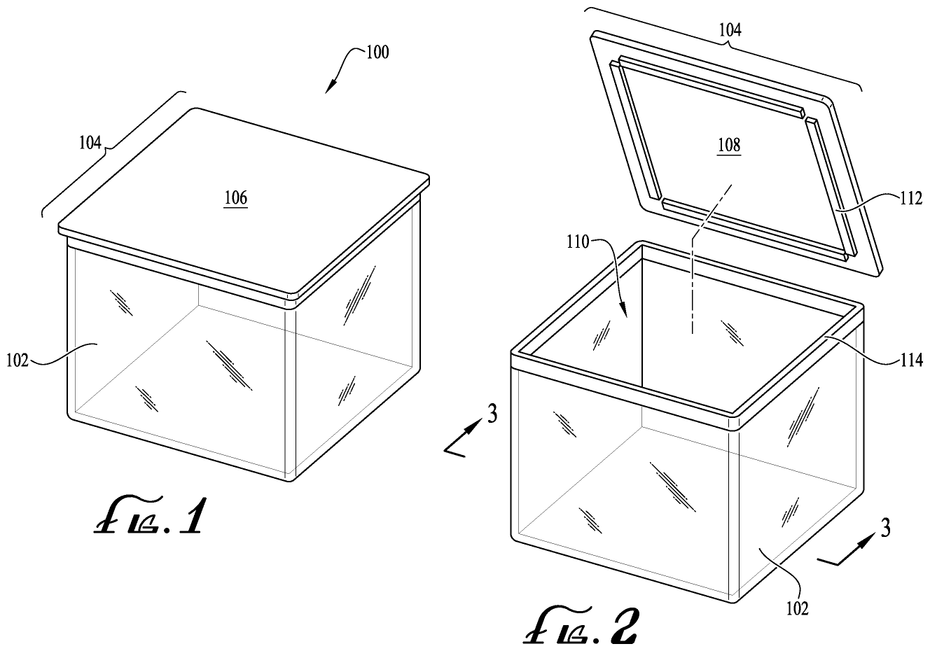

Referring now to FIGS. 1 and 2, seen is a magnetically resealable food storage container 100 having a container body 102, and a lid portion 104. The lid portion 104 may further have a lid external end 106 and a lid internal end 108. The lid external end 106 herein refers to the side of the lid portion 104 which faces away from the container body 102 when the lid portion 104 is engaged with the container body 102. The lid internal end 108 herein refers to the side of the lid portion 104 which faces the internal portion of the container body 102 when the lid portion 104 is engaged with the container body 102. The magnetically resealable food storage container 100 may further have a container opening 110 and a container ledge 114. The lid internal end 108 may further have a one or more than one magnetic closing assembly 112.

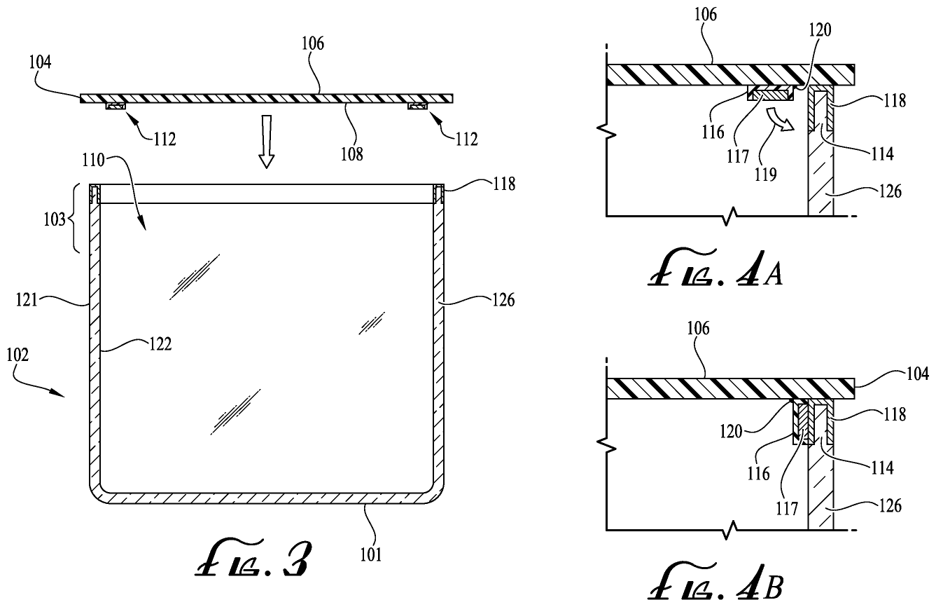

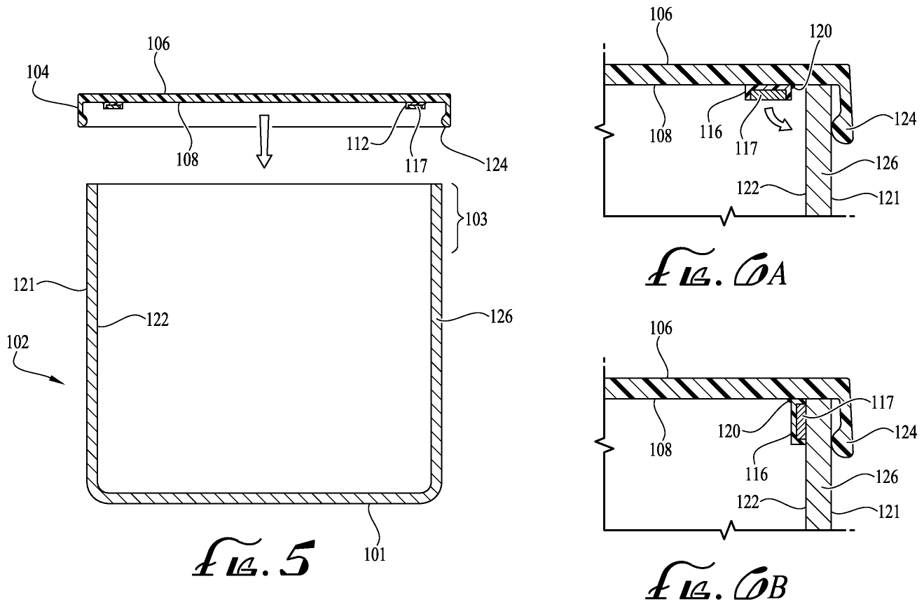

Referring now to FIGS. 3, 4A, and 4B, further seen is a view of the magnetic closing assembly 112 as herein described. Components of the magnetic closing assembly 112 may include a lid magnet housing 116, lid closure magnet 117, and a lid hinge 120. Said lid hinge 120 may produce a reversibly rotational clasping action 119 when near an adjacent magnet, such as the, by way of example only, a container closure magnet 118. Accordingly, when the lid portion 104 is placed on top of the container body 102 with the lid internal end 108 facing the container body 102 the natural magnetic attraction between the lid closure magnet 117 and the container closure magnet 118 may automatically and reversibly attract and attach according to the action indicator of the reversibly rotational clasping action 119 as indicated in the FIG. 4A. Due to the physical properties of magnets, such reversibly rotational clasping action 119 is fully non-permanent and allows a user of the magnetically resealable food storage container 100 to easily place and remove the lid portion 104 from the container body 102 at will. To facilitate said movement between two magnets, the container ledge 114 may function to hold and retain the container closure magnet 118 in place. The magnetic closing assembly 112 in this embodiment folds down to magnetically mate with the container body 102.

Still referring to FIGS. 3, 4A, and 4B, seen are a cross-section of the container body 102 indicating a container upper portion 103 and a bottom container surface 101. The container upper portion 103 may be the uppermost portion of the container body 102 and the bottom container surface 101 may be the lowest most portion of the container body 102. The upper end and the lower end of the container body 102 should be understood in terms of the natural gravitational pull of Earth towards a lowest point of ground, whether that ground be a kitchen counter or some other lowest human-engineered surface, or Earth itself. The bottom container surface 101 will be the lowest portion of the container body 102 and will be nearest to Earth while the container upper portion 103 will be the highest portion of the container body 102 and will be furthest away from the surface of Earth. Additionally seen are a container wall 126, an external container portion 121, and an internal container portion 122. The external container portion 121 may be the external surface of the container body 102, meaning the surface not in contact with materials contained internally of the container body 102. The internal container portion 122 may be the internal surface of the container body 102, meaning the surface in contact with materials contained internally of the container body 102.

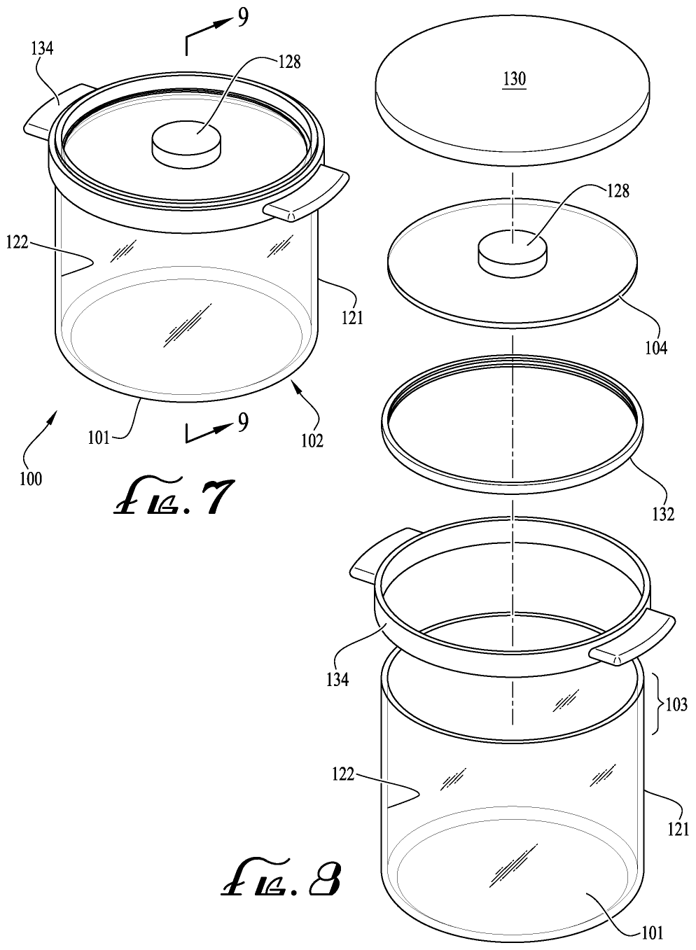

Referring now to FIGS. 5, 6A, and 6B, seen are additional embodiments of the magnetically resealable food storage container 100. Additionally included herein is a lid over-edge guide 124. The lid over-edge guide 124 may be useful in situations where the lid portion 104 and the container body 102 need additional alignment. Such need may arise in cases where, by way of example only, due to manufacturing costs or design considerations, the lid closure magnet 117 does not extend the full length of the container body 102 or lid portion 104. Such situations may arise, by way of example only, when the container body 102 is constructed of a ferric metal. In a situation such as this, the magnetic closing assembly 112 and thus all components associated with the magnetic closing assembly 112 may be located at any point and may be as small as permissible with the limitations of magnetic force.

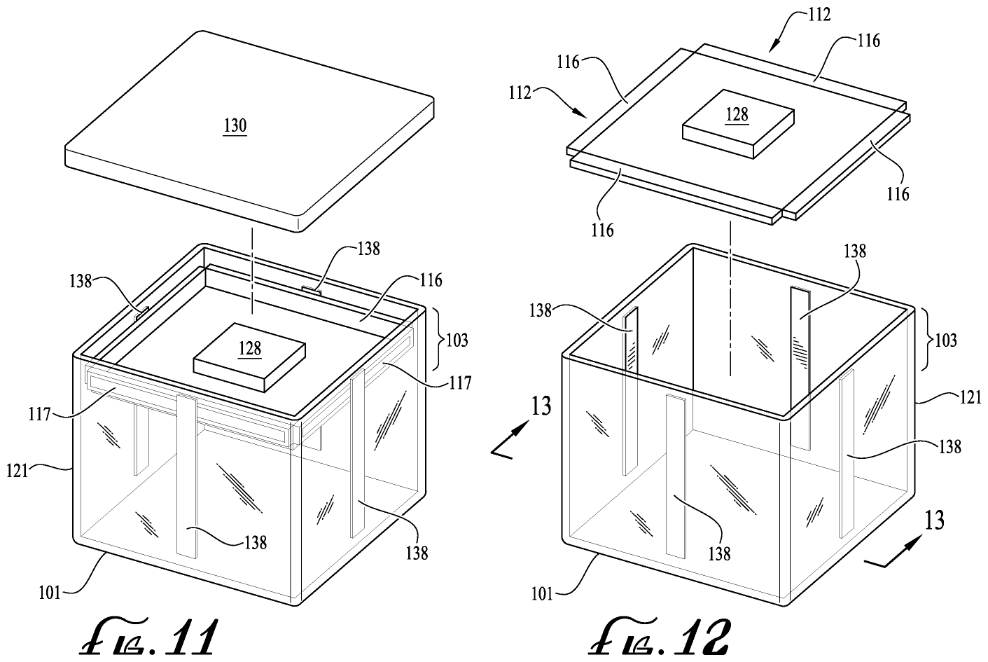

Referring now to FIGS. 7, 8, 9, and 10, seen are rounded embodiments of the magnetically resealable food storage container 100. Seen is a handle 128, an over lid 130, a magnetic lid ring 132, and handle ring 134. The magnetic portion of this embodiment may be the magnetic lid ring 132 and/or the handle ring 134. The magnetic lid ring 132 may be configured to rest against the internal container portion 122 of the container body 102 and may be of an annular shape and sized to be snug against the internal container portion 122 of the container body 102. The handle ring 134 may be configured to rest against the external container portion 121 of the container body 102 and may be of an annular shape and sized to be snug against the external container portion 121 of the container body 102.

Still referring to FIGS. 7, 8, 9, and 10, accordingly, the magnetic attraction of the magnetic lid ring 132 may attract the magnetic handle ring member 136 of the handle ring 134, or in other words, all possible combinations are contemplated. Either magnetic handle ring member 136 or the magnetic lid ring 132 may be either of a ferric material or a magnetic material, provided that the choice results in lid closure. Stated another way, said magnetic attraction may occur via magnetic material in either or both of the magnetic handle ring member 136 or the magnetic lid ring 132, with either the magnetic handle ring member 136 or the magnetic lid ring 132 then being a corresponding ferric metal. Alternatively, both the magnetic handle ring member 136 and the magnetic lid ring 132 may be magnetic and of opposite polarity and may attract to each other. In such a case both the magnetic handle ring member 136 and the magnetic lid ring 132 may be constructed of magnetic material.

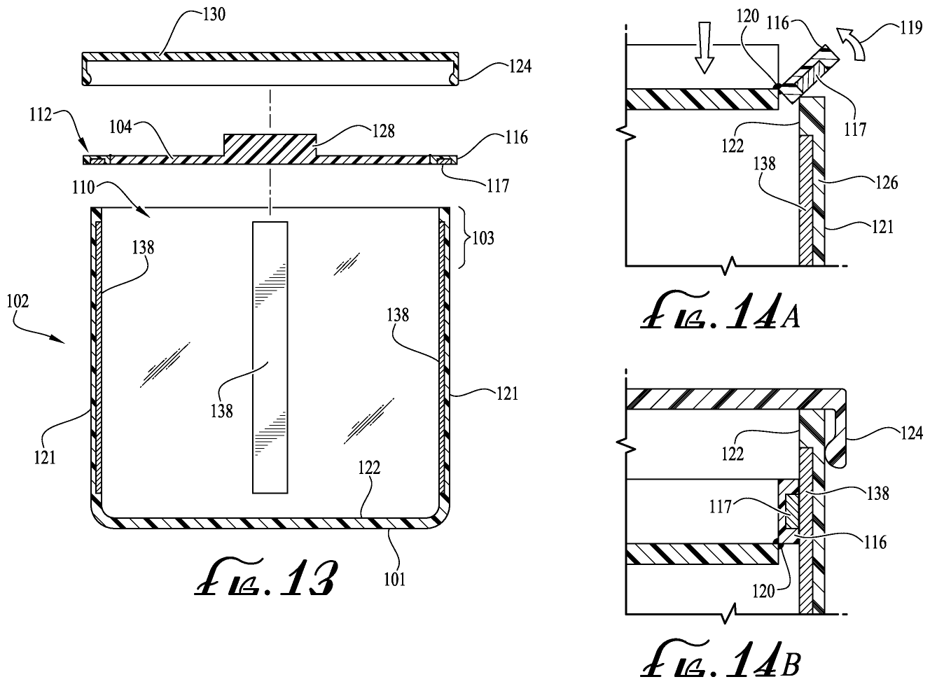

Referring to FIGS. 11, 12, 13, 14A, 14B, 15, and 16 seen are an additional embodiment of the magnetically resealable food storage container 100. Additionally seen are magnetic track 138 running in a vertical fashion from the bottom container surface 101 to the container upper portion 103. Said magnetic tracks may be necessary for situations wherein the container body 102 is constructed from plastic or glass materials. As can be seen, the magnetic track 138 may be mounted to the external container portion 121 or the internal container portion 122. Further, in this embodiment, the magnetic closing assembly 112 may function opposite of prior embodiments. Here, the magnetic closing assembly 112 may hinge such that the magnetic closing assembly 112 flaps in an upward manner than a downward manner. The magnetic closing assembly 112 in this embodiment hinges upward to magnetically mate with the container closure magnet 118 of the container body 102. This is further indicated by the reversibly rotational clasping action 119 indicating an upward direction of travel.

Referring to FIGS. 13 and 15, as can be seen, in some embodiments the magnetic track 138 may be embedded into the external container portion 121 of the container body 102. Such placement of the magnetic track 138 may result in a smooth surface of the internal container portion 122 and may result in vertical travel of the lid portion 104 which is unhindered by excess friction. As seen in FIGS. 11 and 13, some embodiments may additionally contemplate use of the over lid 130 in conjunction with magnetic closing assembly 112 of the lid portion 104. In this embodiment, the over lid 130 may have the

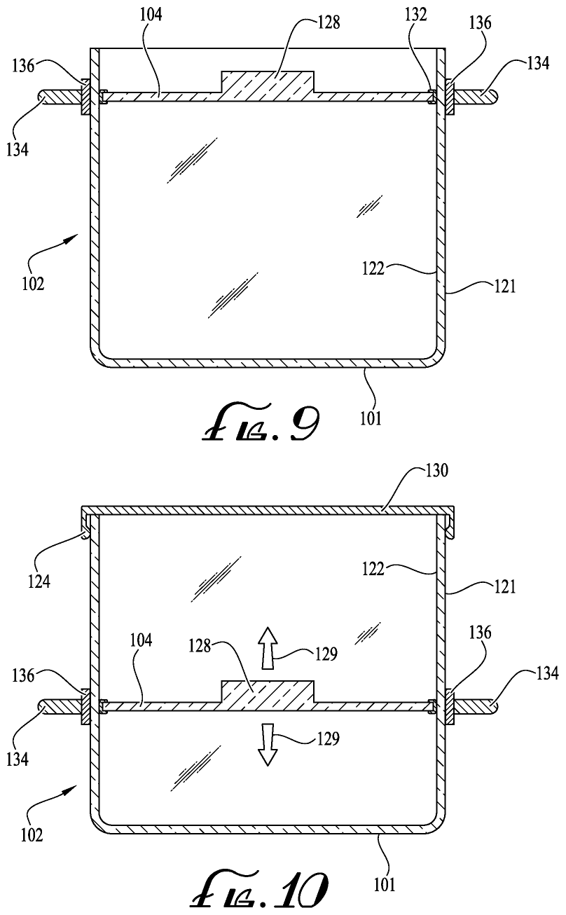

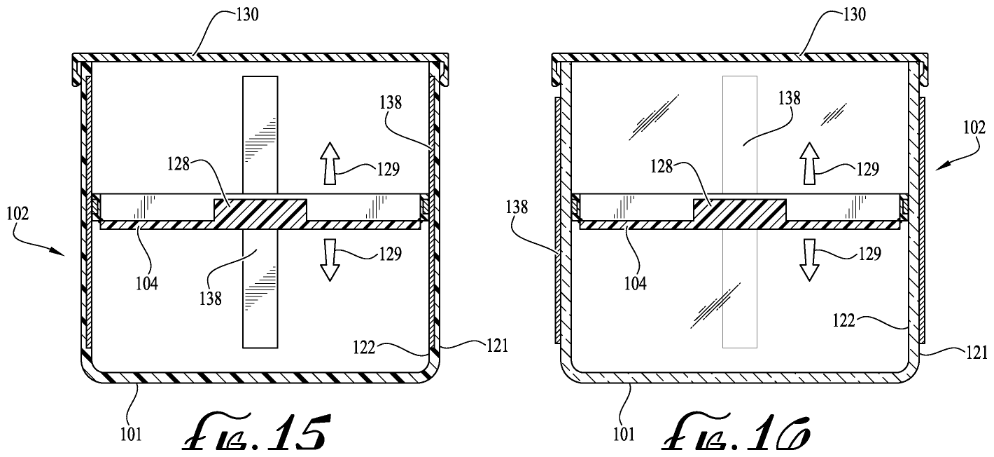

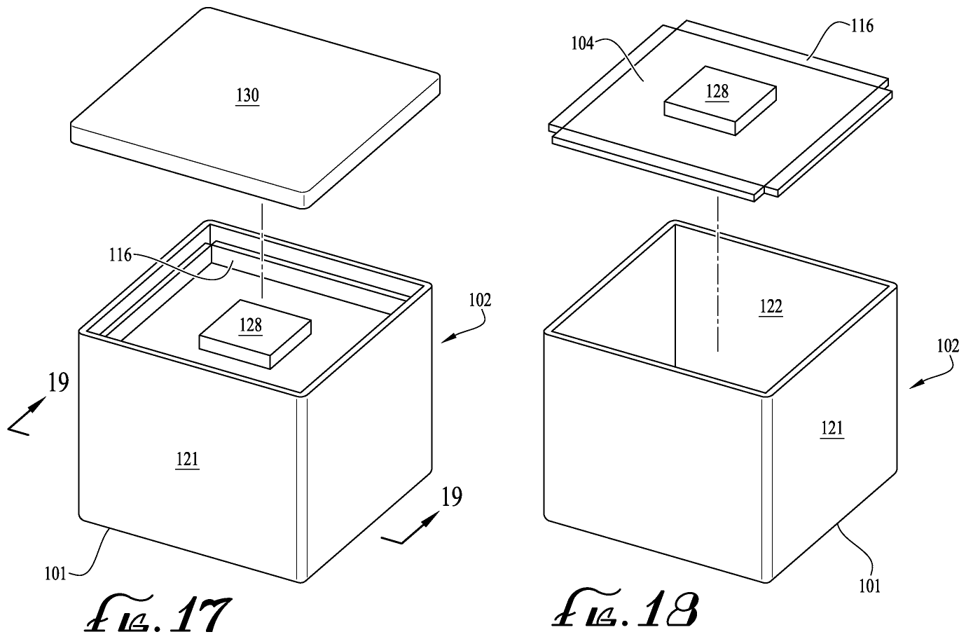

Referring to FIGS. 15 and 16, the previously discussed two methods of placing the magnetic track 138 on the container body 102 are illustrated and can be compared. FIGS. 15 and 16 may be illustrative of plastic and/or glass material construction of the container body 102. Various models of the magnetically resealable food storage container 100 are contemplated, from very high-end models to more economic models. Accordingly, a molding process may be required to achieve the inset magnetic track 138 of FIG. 15. FIG. 16 may therefore be representative of a glass or plastic container body 102, however, such an arrangement of the magnetic track 138 to the external container portion 121 of the container body 102 and may represent the more economic model of the magnetically resealable food storage container 100. FIG. 16 would function similarly to the embodiments indicated in, by way of example only, FIGS. 7 and 8. The lid closure magnet 117 (as seen FIG. 14 for example) would be able to magnetically attract to the magnetic track 138 on the other side of the container body 102.

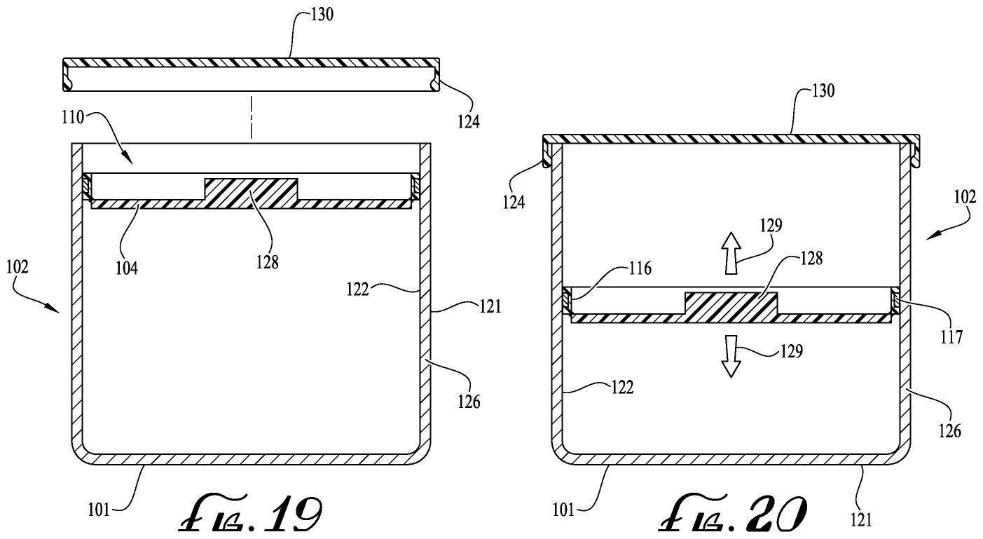

Referring to FIGS. 17, 18, 19, and 20, seen may be a metallic embodiment of the magnetically resealable food storage container 100. Accordingly, because the container body 102, including the container upper portion 103, the bottom container surface 101, the external container portion 121, and the internal container portion 122, may be constructed of a ferric material. The design of this embodiment may be simplified due to a lacking need for a container closure magnet 118, however, this embodiment may not appeal to an end consumer who does not appreciate an industrial look.

Having disclosed the structure of the preferred embodiments, it is now possible to describe its function, operation, and use.

A first embodiment may be described as a magnetically resealable food storage container 100 having a container body 102 and a lid portion 104. The container body 102 may have a container upper portion 103, a container opening 110, a container ledge 114, a container closure magnet 118, and a bottom container surface 101. The container upper portion 103 may define a top and the bottom container surface 101 may define a bottom. The lid portion 104 may an lid external end 106 and a lid internal end 108. The lid internal end 108 may be configured for placement against the container body 102 and may further have a magnetic closing assembly 112. And the magnetic closing assembly 112 may further comprise a lid closure magnet 117, a lid magnet housing 116, and a lid hinge 120. The lid hinge 120 may connect the lid magnet housing 116 to the lid internal end 108 and may be further configured for a reversibly rotational clasping action 119 between the lid closure magnet 117 and the container closure magnet 118.

Referring to the first embodiment of the preceding paragraph, the magnetically resealable food storage container 100 container's body 102 may be constructed of a material selected from metal, glass, or plastic.

Referring to the first embodiment, the magnetically resealable food storage container 100 may have the lid portion 104 which has a lid over-edge guide 124. The lid over-edge guide 124 may be configured to align the lid portion 104 over the container body 102 such that the magnetic closing assembly 112 may be better aligned with the container closure magnet 118.

Referring to the first embodiment, the magnetically resealable food storage container 100 may alternatively have a the lid portion 104 which has a lid over-edge guide 124, the lid over-edge guide 124 may be configured to align the lid portion 104 over the container body 102 such that the magnetic closing assembly 112 is aligned with the container body 102.

Referring to the first embodiment, the magnetically resealable food storage container 100 may have a lid external end 106 of the lid portion 104 has a handle 128, the handle 128 may be configured to aid a user in a vertical motion 129.

Referring to the first embodiment, the magnetically resealable food storage container 100 may have the container closure magnet 118 of the container body 102 being elongated along a vertical axis with respect to the container upper portion 103 and the bottom container surface 101.

Referring to the first embodiment, the magnetically resealable food storage container 100 may have the container body 102 which may further reversibly couple with an over lid 130. The over lid 130 may be configured for use in conjunction with the lid portion 104, the over lid 130 being further configured for engagement to the container body 102 with respect to the lid external end 106 side of the lid portion 104.

A second embodiment may be described as a magnetically resealable food storage container 100, which may have a container body 102 and a lid portion 104. The container body 102 having a container upper portion 103, a container opening 110, a container ledge 114, a magnetic track 138, and a bottom container surface 101. The container upper portion 103 may herein define a top and the bottom container surface 101 may herein define a bottom. The lid portion 104 may have a lid external end 106 and a lid internal end 108. The lid internal end 108 may be configured for placement towards the bottom container surface 101 and may further have a magnetic lid ring 132 and a handle ring 134. And, the magnetic lid ring 132 may be configured for reversible engagement with the internal end of the container body 102 and the handle ring 134 may be configured for reversible magnetic connection with magnetic lid ring 132.

Referring to the second embodiment, the magnetically resealable food storage container 100 may have the container body 102 constructed from a material selected from metal, glass, or plastic.

Referring to the second embodiment, the magnetically resealable food storage container 100 may have the container body 102 as being capable of further reversible coupling with an over lid 130. The over lid 130 may be configured for use in conjunction with the lid portion 104. The over lid 130 may be further configured for engagement to the container body 102 with respect to the lid external end 106 side of the lid portion 104.

Referring to the second embodiment, the magnetically resealable food storage container 100 may have the lid external end 106 of the lid portion 104 further having a handle 128; the handle 128 may be to aid a user in a vertical motion 129.

Referring to the second embodiment, the magnetically resealable food storage container 100, wherein the vertical motion 129 of the handle ring 134 may cause the magnetic lid ring 132 to match the vertical motion 129 of the handle ring 134 due to reversible magnetic coupling.

A third embodiment may be described as a magnetically resealable food storage container 100, which may have a container body 102 and a lid portion 104. The container body 102 may have a container upper portion 103, a container opening 110, a container ledge 114, a container closure magnet 118, and a bottom container surface 101. The container upper portion 103 herein may be defining of a top and the bottom container surface 101 herein may be defining of a bottom. The container closure magnet 118 of the container body 102 may be elongated along a vertical axis with respect to the container upper portion 103 and the bottom container surface 101. The lid portion 104 may have a lid external end 106 and a lid internal end 108. The lid internal end 108 may be configured for placement against the container body 102 and may further have a magnetic closing assembly 112. And, the magnetic closing assembly 112 may further have a lid closure magnet 117, a lid magnet housing 116, and a lid hinge 120. The lid hinge 120 may be connecting the lid magnet housing 116 to the lid internal end 108 and may be configured for a reversibly rotational clasping action 119 between the lid closure magnet 117 and the container closure magnet 118.

Referring to the third embodiment, the magnetically resealable food storage container 100 may have the container body 102 being constructed of a material selected from the group of metal, glass, or plastic.

Referring to the third embodiment, the magnetically resealable food storage container 100 may have the lid portion 104 further having a lid over-edge guide 124. The lid over-edge guide 124 may therein be configured to align the lid portion 104 over the container body 102 such that the magnetic closing assembly 112 is aligned with the container closure magnet 118.

Referring to the third embodiment, the magnetically resealable food storage container 100 may alternatively have the lid portion 104 further having a lid over-edge guide 124. The lid over-edge guide 124 may therein be configured to align the lid portion 104 over the container body 102 such that the magnetic closing assembly 112 is aligned with the container body 102.

Referring to the third embodiment, the magnetically resealable food storage container 100 may further have the lid external end 106 of the lid portion 104 having a handle 128. The handle 128 may be configured to aid a user in a vertical motion 129.

Referring to the third embodiment, the magnetically resealable food storage container 100 may have the container body 102 as being further reversibly couple-able with an over lid 130, the over lid 130 being configured for use in conjunction with the lid portion 104. The over lid 130 may be further configured for engagement to the container body 102 with respect to the lid external end 106 side of the lid portion 104.

While embodiments of the present disclosure have been illustrated and described, it is not intended that these embodiments illustrate and describe all possible forms of this disclosure. Rather, the words used in the specification are words of description rather than limitation, and it is understood that various changes may be made without departing from the spirit and scope of the disclosure.

Accordingly, it is not intended that the various embodiments be limited except by the appended claims. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. A magnetically resealable food storage container, comprising:
a container body and a lid portion;
the container body having a container upper portion, a container opening, a container ledge, a container closure magnet, and a bottom container surface, the container upper portion herein defining a top and the bottom container surface herein defining a bottom;
the lid portion having a lid external end and a lid internal end, the lid internal end being configured for placement against the container body and further having a magnetic closing assembly; and,
the magnetic closing assembly further comprising a lid closure magnet, a lid magnet housing, and a lid hinge, the lid hinge connecting the lid magnet housing to the lid internal end and configured for a reversibly rotational clasping action between the lid closure magnet and the container closure magnet.

2. The magnetically resealable food storage container of claim 1, wherein the container body is constructed of a material selected from the group consisting of metal, glass, or plastic.

3. The magnetically resealable food storage container of claim 1, wherein the lid portion further has a lid over-edge guide, the lid over-edge guide therein configured to align the lid portion over the container body such that the magnetic closing assembly is aligned with the container closure magnet.

4. The magnetically resealable food storage container of claim 3, wherein the lid over-edge guide is configured to align the lid portion over the container body such that the magnetic closing assembly is aligned with the container body.

5. The magnetically resealable food storage container of claim 2, wherein lid external end of the lid portion has a handle, the handle being configured to aid a user in a vertical motion.

6. The magnetically resealable food storage container of claim 5, wherein the container closure magnet of the container body being elongated along a vertical axis with respect to the container upper portion and the bottom container surface.

7. The magnetically resealable food storage container of claim 2, wherein the container body further reversibly couples with an over lid, the over lid being configured for use in conjunction with the lid portion, the over lid being further configured for engagement with the container body.

8. A magnetically resealable food storage container, comprising:
a container body and a lid portion;
the container body having a container upper portion, a container opening, a container ledge, a magnetic track, and a bottom container surface, the container upper portion herein defining a top and the bottom container surface herein defining a bottom;
the lid portion having a lid external end and a lid internal end, the lid internal end configured for placement towards the bottom container surface and further having a magnetic lid ring and a handle ring; and,
the magnetic lid ring being configured for reversible engagement with the internal end of the container body, the handle ring being configured for reversible magnetic connection with magnetic lid ring.

9. The magnetically resealable food storage container of claim 8, wherein the container body is constructed of a material selected from the group consisting of metal, glass, or plastic.

10. The magnetically resealable food storage container of claim 8, wherein the container body further reversibly couples with an over lid, the over lid being configured for use in conjunction with the lid portion, the over lid being further configured for engagement to the container body with respect to the lid external end side of the lid portion.

11. The magnetically resealable food storage container of claim 8, wherein the lid external end of the lid portion has a handle, the handle configured to aid a user in a vertical motion.

12. The magnetically resealable food storage container of claim 8, wherein the vertical motion of the handle ring causes the magnetic lid ring to match the vertical motion of the handle ring due to reversible magnetic coupling.

13. A magnetically resealable food storage container, comprising:
a container body and a lid portion;
the container body having a container upper portion, a container opening, a container ledge, a container closure magnet, and a bottom container surface, the container upper portion herein defining a top and the bottom container surface herein defining a bottom;
the container closure magnet of the container body being elongated along a vertical axis with respect to the container upper portion and the bottom container surface.
the lid portion having a lid external end and a lid internal end, the lid internal end being configured for placement against the container body and further having a magnetic closing assembly; and,
the magnetic closing assembly further having a lid closure magnet, a lid magnet housing, and a lid hinge, the lid hinge connecting the lid magnet housing to the lid internal end and configured for a reversibly rotational clasping action between the lid closure magnet and the container closure magnet.

14. The magnetically resealable food storage container of claim 13, wherein the container body is constructed of a material selected from the group consisting of metal, glass, or plastic.

15. The magnetically resealable food storage container of claim 13, wherein the lid portion further has a lid over-edge guide, the lid over-edge guide therein configured to align the lid portion over the container body such that the magnetic closing assembly is aligned with the container closure magnet.

16. The magnetically resealable food storage container of claim 13, wherein the lid over-edge guide is configured to align the lid portion over the container body such that the magnetic closing assembly is aligned with the container body.

17. The magnetically resealable food storage container of claim 14, wherein the lid external end of the lid portion has a handle, the handle being configured to aid a user in a vertical motion.

18. The magnetically resealable food storage container of claim 14, wherein the container body further reversibly couples with an over lid, the over lid being configured for use in conjunction with the lid portion, the over lid being further configured for engagement to the container body with respect to the lid external end side of the lid portion.
